(19) United States
(12) Patent Application Publication
(10) Pub. No.: US 2010/0179859 A1
(43) Pub. Date: Jul. 15, 2010

(54) Method and System for Facilitating On-Line Shopping

(76) Inventors: Bruce L. Davis, Lake Oswego, OR (US); William Y. Conwell, Portland, OR (US); Joel R. Meyer, Lake Oswego, OR (US)

Correspondence Address: DIGIMARC CORPORATION, 9405 SW GEMINI DRIVE, BEAVERTON, OR, 97008, US

(21) Appl. No.: 12/502,013

(22) Filed: Jul. 13, 2009

Related U.S. Application Data
(62) Division of application No. 09/502,542, filed on Feb. 10, 2000, now abandoned.

(51) Int. Cl. G06Q 30/00; G06Q 10/00; G06Q 50/00

(52) U.S. Cl. 705/10; 705/27

(57) ABSTRACT

A shopper is presented with a customized online store whose inventory is defined by the shopper. In one embodiment, specification of the inventory is conducted in a bricks and mortar store—either during checkout, or by the shopper walking the aisles and scanning items with a barcode scanner pen or the like. The inventory may be defined—at least in part—by scanning items in the shopper's home. A variety of other novel features useful in on-line shopping are also disclosed.

### RELATED APPLICATION DATA

This application is a division of application Ser. No. 09/502,542, filed Feb. 10, 2000, the contents of which are incorporated herein by reference.

### TECHNICAL FIELD

The present technology relates to on-line shopping, including the compilation of “favorites” lists useful in such shopping.

### BACKGROUND AND SUMMARY OF THE TECHNOLOGY

On-line shopping is popular with certain technically adventurous segments of the public, but various drawbacks have prevented more widespread adoption.

Consider on-line grocery stores. These virtual storefronts offer an impressive inventory of choices, but have cumbersome user interfaces for product selection. A first-time shopper must typically type in the name of a product desired, e.g., Jif peanut butter. After entering this data, the user is presented with a menu of products that meet the search criteria (e.g., Jif Chunky, Jif Smooth, each in 4 ounce, 8 ounce, and 16-ounce sizes), together with associated prices. The user then types data into a quantity box to indicate how many of each item is desired. The user must then repeat this process with each other item on the user's shopping list. The overall experience is tedious and time consuming. This user interface hurdle causes many first-time users to give up in despair.

The situation is much improved for shoppers who stick with the process and successfully make one or more on-line orders. Items previously purchased by such users are detailed in list (a “favorites list”) that is presented when the user next signs-on to the store, and can be reordered without the tedious typing-based navigation/selection process just-detailed.

In accordance with one embodiment of the present technology, the initial user-interface hurdle to a satisfying shopping experience is overcome by permitting the user to compile a favorites list through shopping in one or more bricks-and-mortar stores. Whenever a customer passes through the checkout, the purchased items are added to a favorites list associated with that user. When the user shops on-line, a personalized shopping environment is presented, featuring the items previously purchased in the bricks and mortar store(s).

One particular method includes: presenting a collection of retail items, each having an indicia associated therewith, in a bricks and mortar store offering items for sale; sensing the indicia associated with selected ones of said items; compiling a list identifying the items whose indicia were sensed; storing said list in a data structure associated with a user; later recalling said list; using the recalled list to present a customized selection of items in an on-line shopping environment; and receiving input from a user identifying a subset of items from said customized selection of items.

Another particular method relates to conducting an online shopping session by: identifying a user by reference to a login identifier; recalling a list of products associated with the user; presenting products from said list to the user for selection; receiving user selections of products to be purchased; receiving an indication that the user is finished selecting products; and thereafter querying the user regarding possible purchase of an item not selected by the user but on said recalled list, before completing the online shopping session.

Still another method comprises: logging a shopper's habits or preferences exhibited in an on-line shopping environment in one or more database records associated with that shopper; and recalling said logged database record in a bricks and mortar store and using the logged information in connection with bricks and mortar shopping by said user.

Yet another arrangement comprises—in an on-line shopping method—displaying a virtual shopping aisle with graphical—rather than strictly textual—representations of items for sale, wherein items of potential interest to a shopper are presented more prominently than other items.

In some embodiments, the store can perform statistical analyses of buying behavior over time and suggest grocery lists based on what it learns about patterns of buying behavior.

In still other embodiments, merchants can participate in a consortium that provides customers with a service that captures descriptions of goods purchased, at the customer's discretion, to facilitate replenishment of consumables of all kinds.

The foregoing and additional features and advantages of the present technology will be more readily apparent from the following detailed description, which proceeds with reference to the accompanying drawings.

### BRIEF DESCRIPTION OF THE DRAWINGS

FIG. 1 is a block diagram showing computers in one embodiment of the present technology.

FIG. 2 is a flow chart detailing aspects of a second embodiment of the present technology.

FIG. 3 is a block diagram showing computers used in the FIG. 2 embodiment.

FIGS. 4-9 are flow charts depicting methods according to different embodiments of the present technology.

### DETAILED DESCRIPTION

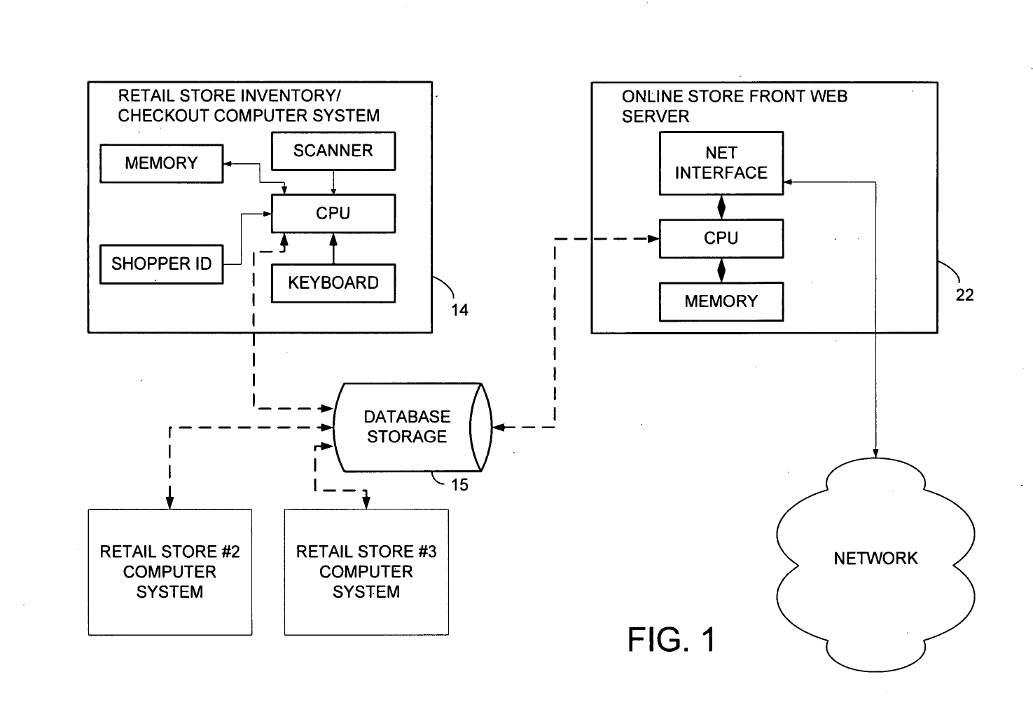

Referring to FIG. 1, in a first embodiment of the present technology a shopper identifies him- or herself to a checkout computer 14 at a bricks and mortar store (e.g., a supermarket). Identification can be used by an ID card, entry of an identifier on a keypad, or other means. (The checkout computer typically forms part of a larger distributed computing environment that also includes the store's inventory control system.)

As the shopper's goods are scanned for checkout, a favorites list corresponding to the shopper is updated with the purchased goods. The favorites list is typically stored in a database storage 15 remote from the checkout stand (which may or may not comprise a separate computer system, and may form part of an on-line storefront computer 22). Several different stores—branches of a single stores, or unaffiliated stores—can pool data in a common database 15.

When the shopper thereafter shops on-line at a participating vendor through the on-line storefront computer 22, a list detailing all goods previously-purchased at the bricks and mortar store(s) is retrieved from storage 15 and presented to the user, permitting the on-line shopping experience to be enhanced, as detailed below.

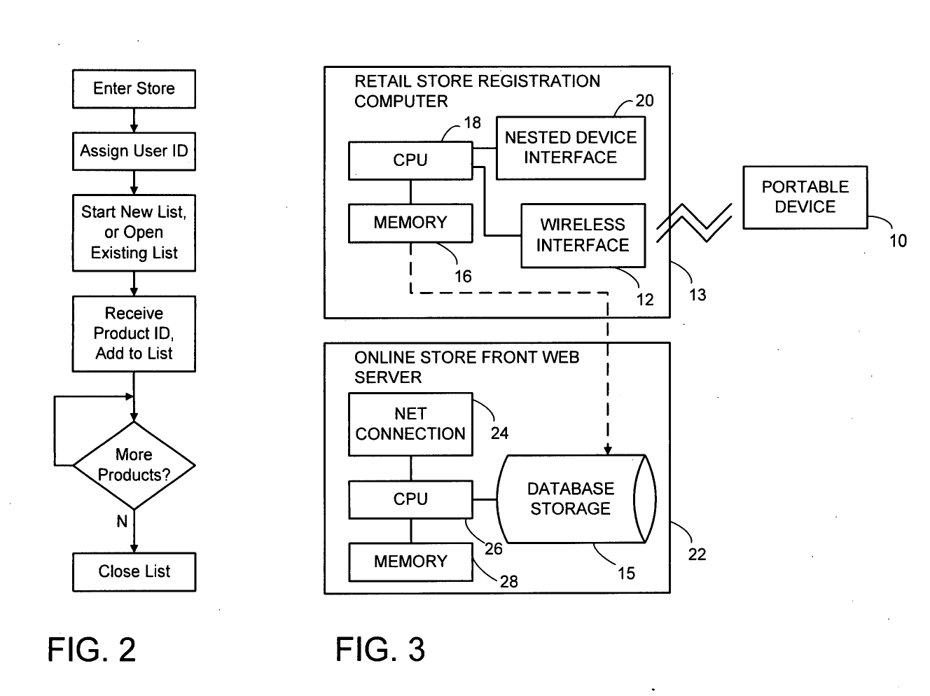

FIG. 2 details a method used in a second embodiment—one in which product selection is accomplished without purchasing goods at checkout. In such embodiment, the shopper enters a bricks and mortar store and registers to use a selection device, such as a handheld scanner 10. (Registration can involve entering name, email address, and/or other identification information into a terminal. A user ID can be assigned if an ID for that user does not already exist.)

Walking the aisles, the user quickly scans each item that may be of future interest. Each successful “read” of a product indicia is confirmed with an audio tone or a visible indication. A corresponding product ID (e.g., an SKU, or barcode identifier) is added to a list maintained for that user. After wandering the aisles for ten or 15 minutes, the user has compiled a list of items that can be presented in a virtual store customized for that user. This arrangement permits a user to compile a large universe of products of potential interest to populate that user's on-line personal store, without the requirement of purchasing them all.

In some embodiments, the scanner device 10 is a barcode reader (e.g., a laser pen with associated decoder circuitry). Other arrangements can of course be used, e.g., an image capture device that captures images of the desired products (and may decode a watermark steganographically embedded within the image data), an RF ID sensor, etc.

Some scanner devices compile the product IDs in a memory within the unit, and download same to a central computer when the device is returned after use. Others relay the product IDs by wireless to a central computer in real time, as the products are scanned.

In other embodiments, the selection device needn't be an active device. Instead, for example, the user can have a passive barcode-encoded card that is presented to a shelf-mounted reader associated with each item. These readers are linked to the central computer, and relay the identities of users who identify themselves as interested in the corresponding product. Magnetic stripe cards, and readers, can similarly be employed. The cards may be issued by the store especially for this product selection purpose, or the system can be arranged to employ cards already in the user's possession (e.g., credit card, drivers license, etc.) In the latter case, customer registration upon entering the store can include presenting the user's card to a registration terminal, so that it can be associated with that user when later presented during the user's walk of the aisles.

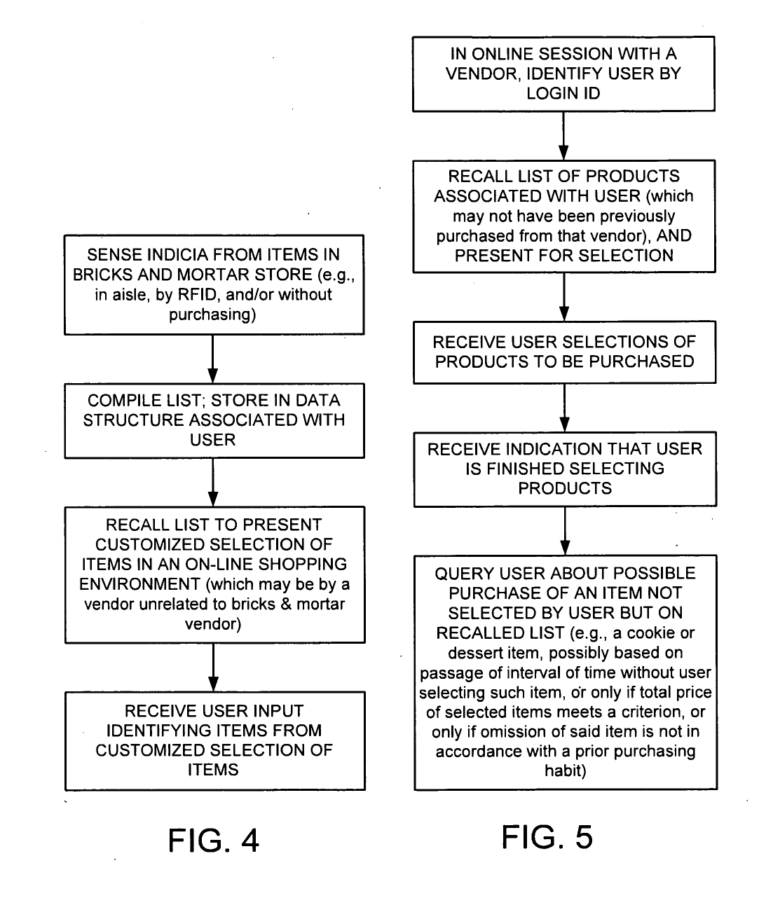

Hardware associated with the FIG. 2 method is shown in FIG. 3. The device 10 is coupled through a wireless interface 12 to a retail store registration computer 13. Product identifier data from the device 10 is stored into a memory 16, under control of a CPU 18. The illustrated computer also includes a nest 20 for receiving product selection data from devices 10 that buffer same in an internal memory rather than radio-relaying same immediately.

The computer 22 for the online storefront is again shown in FIG. 3 and can be seen to include a net connection 24 (e.g., a T-1 or T-3 interface), a CPU (or CPUs) 26, a memory 28, and disk storage 30. The computer is programmed in accordance with software instructions loaded into memory 28. This software includes operating system software (e.g., Windows NT, Sun Solaris, etc.), and applications software. The applications software includes web server software and database software for use in connection with database storage 15. Examples of the latter include Microsoft SQL Server, Oracle 8, etc. Memory 28 also includes instructions defining a graphical interface through which a user interacts with the online store.

Database 15 can include a record for each user, stored in association with the user's ID. In some embodiments, each record comprises only product IDs. In other embodiments additional information may be included. Such other information may include a category for each item (e.g., dairy, cookie/dessert, beverage), a textual description, etc. (In embodiments omitting this information from the database, the information may nonetheless be associated with the products through a separate database, using the product IDs as keys.) User profile information may also be included in each user's database record.

When a user visits an on-line store, the store system solicits a user ID. Once entered, the system recalls that user's list of favorites and populates the user's custom store accordingly. The user then identifies products to be purchased from this personalized universe of products. If the user consumer wants to purchase an item not in the inventory, the user can select a link to invoke one of the prior art universal product selection user interfaces, e.g., a text-based search, to obtain the desired product. Once all the desired items have been selected, the user indicates a preferred payment method, notes in-store pick-up or home delivery, and is done.

Having an inventory of items customized to the user enables various enhancements to be made to the user's shopping experience. For example, if a user enters an order devoid of any items in a “Dessert/cookie” category, the system can present a query that presents dessert/cookie items from that user's favorite list—as the order is being finalized—in case the omission was an oversight.

Such suggestion of purchases may be triggered only if the purchase meets one or more criteria. The criteria can include total purchase size (e.g., over $75), time since last order (e.g., no cookies ordered for 30+ days), etc.

The on-line system can also track the user's purchase habits. If the user customarily orders 3 half gallons of skim milk every week, and a weekly order is entered without such an item, the system can query whether such item should be included before finalizing the order.

The user interface presented to the user in the on-line store can include buttons, links, or other UI controls permitting the user to obtain additional information on the items in the customized store. This additional information can include nutrition data, the same product in other packaging/size options, comparable products of different brands, product ratings, price comparison data, etc. (Price comparison data may be entered by the user to identify, e.g., the price at which such item has been purchased previously, or the price for which the item sells in the local, conventional, store.)

The present technology offers the possibility of hybrid stores, presenting the user a single on-line experience from which purchases can be made from disparate vendors. Grocery items may be provided through webvan.com; drugs can be provided through planetrx.com; flowers can be provided through ftd.com, etc. The user's product preferences from each of these vendors can be combined and presented in a unified user interface from a single site. Orders can be dispatched by the on-line system to each of the vendors whose products are specified. Each vendor can fulfill their part of the order independently, or a consolidated distribution system can be employed (e.g., a distribution center shared by several vendors), permitting the inventory to be pulled, and the order fulfilled, in a single delivery.

In other embodiments, a user's “favorites list” of products can be mapped to several different on-line retailers so as to optimize pricing. Thus, for example, a user may summon his or her personalized on-line store, and select from it 5 different items. The web server 22 can price each of the items from several different vendors—either transparently to the user or not. Further considering delivery or other charges, the system can tailor one or more vendor orders so as to procure all of the desired orders at the lowest net price. (In some cases, an item might be ordered from a higher-priced vendor if the applicable delivery charge yields a lower total price.)

Having described and illustrated the principles of our technology with reference to specific embodiments, it will be recognized that the principles thereof can be implemented in other, different, forms.

For example, while the detailed embodiments employ two or more distinct computer systems—one for data collection in the bricks and mortar facility, another for the online storefront, these functions can be consolidated in a single computer.

Similarly, while the detailed embodiment contemplated an on-line store employing a graphical user interface, in other embodiments interfaces employing voice recognition, gestures, and other technologies can naturally be used.

The detailed embodiment contemplated that a conventional supermarket would serve as the facility in which user selection of items for their customized store is conducted. In other embodiments, much smaller facilities can be employed. For example, a storefront (e.g., in a mall) can be stocked with one sample of each item in a supermarket's inventory. Such a storefront can employ product placement conventions that are familiar to shoppers (e.g., grouping baking supplies located together; placing peanut butter next to jelly, ketchup next to mustard, etc.), rather than the unfamiliar paradigms (e.g., alpha or “category” groupings) commonly employed in on-line systems. Without stocking inventory for sale, the storefront can be much smaller, while still permitting the user to pick and up read packaging in the familiar manner.

Moreover, it is not necessary that a user visit a store to scan the items desired in the user's customized store inventory. Instead, samples of the items in the user's residence can be used as the basis for such an inventory. Data from such items can be entered into a user computer by various means, including typing the barcode identifier, scanning with a laser pen, imaging with a web cam, etc.

In still other embodiments, the on-line store can display to a shopper a virtual shopping aisle featuring graphical—rather than strictly textual—representations of items for sale. Thus, a box of Ritz crackers can be represented by the familiar red box, or by the familiar logo, or both. Items of potential interest to a shopper (and/or on-sale items) are presented more prominently (e.g., larger, more brightly, etc.) than other items. The items of potential interest can be determined by reference to the shopper's prior shopping history. The shopper can navigate the aisle using conventional virtual reality (e.g., 3D) navigation techniques. For efficiency sake, the graphical rendering engine and related models can be run on the shopper's computer (i.e., the “client”) rather than on the server computer. Known Internet push or pull technology can be used to update the item data, if desired.

While the detailed embodiment contemplates systems dedicated to shopping, in other implementations the shopping attributes can be a subset of a larger group of a system's features. For example, the present assignee's MediaBridge technology (detailed, e.g., in application Ser. No. 09/343,104, filed Jun. 29, 1999, incorporated herein by reference) foreshadows the day in which visual—and other computer interfaces are ubiquitous. Each item seen by a computer has an identity that can be discerned by the computer (e.g., by barcodes, digital watermarks, RF IDs, etc.). Internet-like linking based on the discerned identities of the perceived items establishes connections with remote resources that provide information or services related to (or simply triggered by) the system's encounter with a physical object. In such systems, objects identified as groceries or the like by the system can be automatically logged (locally or remotely) in a grocery favorites list, or otherwise using a “store” metaphor, facilitating efficient online (or offline) shopping in general.

While the detailed description particularly considered purchasing grocery items, the same techniques are naturally applicable in all manner of retail sales.

Naturally, features and details described in connection with the first embodiment (compiling the list at checkout) can be employed in connection with the second embodiment (compiling the list without purchasing), and vice versa. Similarly, while the detailed embodiments collected information from a shopper's encounters with physical objects, and used them to enhance an on-line shopping experience, the converse can naturally be practiced. That is, information collected during on-line shopping sessions (e.g., product preferences, shopping habits) can be used thereafter in a bricks and mortar facility to enhance the shopper's experience there.

While the detailed embodiment contemplated central storage of product lists for several users in a single database, in other arrangements each user's list may be stored in that user's computer. (The list can be relayed from the bricks and mortar storefront to the user's computer by the internet or otherwise.) The application that presents the shopping experience can still be a remote server—that loads the product list from local storage on the user's computer and uses same in presenting the virtual storefront to the user—or the application can execute on the user's computer.

While the detailed arrangement particularly considered an arrangement in which the user's favorites list is compiled through physical interaction with products, other inventive aspects of the detailed technology can be practiced with favorites lists compiled otherwise (e.g., through prior art, prior ordering experience).

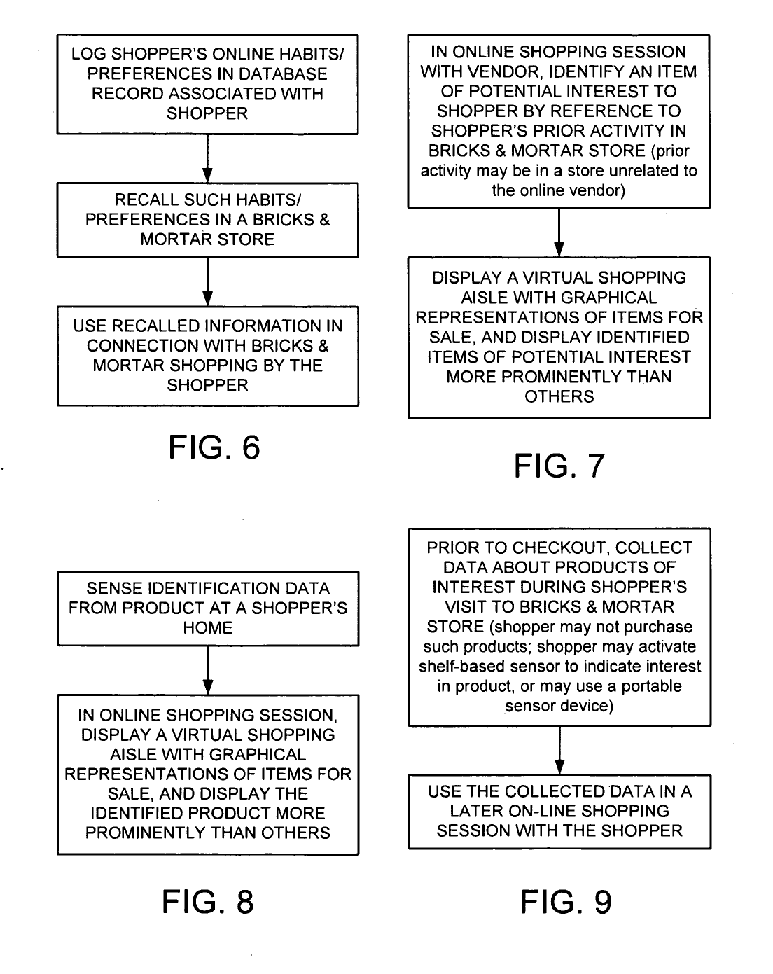

FIGS. 4-9 are flow charts depicting methods according to certain of the above-described arrangements.

In view of the wide variety of embodiments to which the principles of our technology can be applied, it should be recognized that the detailed embodiment is illustrative only and should not be taken as limiting the scope of the technology. Rather, we claim all such embodiments as may come within the scope and spirit of the following claims, and equivalents thereto.

We claim:

1. A method comprising:
in connection with a user's expression of interest in a first item available for sale from a first vendor, adding information associated therewith to a data structure associated with the user; and
recalling data from said data structure in connection with presenting to the user information about one or more items offered for sale by a second vendor;
wherein the first and second vendors are different.

2. A method comprising:
in connection with a user's expression of interest in a first item available for sale from a first vendor, adding information associated therewith to a data structure associated with the user;
in connection with a user's expression of interest in a second item available for sale from a second vendor different than the first vendor, adding information associated therewith to said data structure; and
in a subsequent on-line shopping session by said user, populating a presentation of merchandise offerings that is displayed to the user in accordance with information from said data structure.

3. A method comprising:
collecting first user preference data relating to items of a first type, items of the first type being available from a first vendor;
collecting second user preference data relating to items of a second type different than the first, items of the second type being available from a second vendor different from the first;
using said collected first and second user preference data in populating a presentation of merchandise offerings in a hybrid on-line store, the hybrid on-line store presenting a user a single on-line experience from which purchases can be made from disparate vendors, including the first and second vendors, and wherein items purchased from different vendors are respectively shipped by said different vendors.

4. The method of claim 3 wherein items of the first type are grocery items, drugstore items, or floral items, and items of the second type are a different one of said just-listed item types.
